(19) United States
(12) Patent Application Publication
(10) Pub. No.: US 2019/0059608 A1
(43) Pub. Date: Feb. 28, 2019

(54) CHAIR AND SMART LUMBAR PILLOW SYSTEM FOR CHAIR

(71) Applicant: BOE TECHNOLOGY GROUP CO., LTD., Beijing (CN)

(72) Inventors: Han Yan, Beijing (CN); Qi Zeng, Beijing (CN)

(21) Appl. No.: 16/049,796

(22) Filed: Jul. 30, 2018

(30) Foreign Application Priority Data
Aug. 22, 2017 (CN) 201710724990.7

(51) Int. Cl. A47C 31/12; A47C 7/46; B60N 2/02; B60N 2/66

(52) U.S. Cl. CPC A47C 31/126; A47C 7/467; B60N 2002/0268; B60N 2/665; B60N 2002/026; B60N 2/0244

(57) ABSTRACT

In an embodiment, there is provided a chair including: a chair body; at least one sensing element on the chair body for sensing a human body pressure on the chair body; at least one gasbag on the chair body for supporting a waist of a human body; a gas pump for performing inflation and deflation of the at least one gasbag; and a control assembly in signal connection with the at least one sensing element for controlling the gas pump to perform inflation and deflation of the at least one gasbag according to information acquired by the sensing element.

### CROSS-REFERENCE TO RELATED APPLICATION

This application claims priority to Chinese Patent Application No. 201710724990.7 filed on Aug. 22, 2017 in the State Intellectual Property Office of China, the disclosure of which is hereby incorporated by reference in its entirety.

### TECHNICAL FIELD

The present disclosure relates to the field of furniture technology, and particularly, to a chair and a smart lumbar pillow system for chair.

### BACKGROUND

With the improvement of people's living standards, people have higher requirements for comfort of various kinds of chairs. At present, in most chairs, the shape of the backrest is fixed. When people work or study in chairs for a long time, the lumbar vertebrae is prone to fatigue and it even causes lumbar disc herniation and other diseases, causing physical discomfort and thus reducing people's work efficiency or learning effect.

### SUMMARY

According to an aspect of the present disclosure, there is provided a chair comprising:

a chair body;

at least one sensing element on the chair body for sensing a human body pressure on the chair body;

at least one gasbag on the chair body for supporting a waist of a human body;

a gas pump for performing inflation and deflation of the at least one gasbag; and

a control assembly in signal connection with the at least one sensing element for controlling the gas pump to perform inflation and deflation of the at least one gasbag according to information acquired by the sensing element.

In one embodiment, the chair body comprises a chair frame and a lumbar pillow, and the at least one gasbag is between the chair frame and the lumbar pillow.

In one embodiment, the at least one sensing element comprises a plurality of sensing elements on the chair frame.

In one embodiment, the chair frame comprises a backboard and a seat board, and both the backboard and the seat board are provided with the sensing elements.

In one embodiment, the backboard and the seat board are respectively provided with two to four of the sensing elements, and the sensing elements are substantially symmetrically arranged along a central line of the chair body.

In one embodiment, the at least one gasbag comprises a plurality of gasbags respectively on the backboard and the seat board.

In one embodiment, the chair further comprises a manual control switch connected to the gas pump and configured for manually performing inflation and deflation of the at least one gasbag.

In one embodiment, the control assembly comprises: a data processor for processing the information from the at least one sensing element and outputting an electrical signal, and a memory in signal connection with the data processor for storing a user data.

In one embodiment, the chair body is provided with an identification device for identifying different users.

In one embodiment, the control assembly is configured for: retrieving the user data stored in the memory according to an identification of user identified by the identification device, and controlling the gas pump to perform inflation and deflation of the at least one gasbag according to the user data.

In one embodiment, the identification device comprises at least one of a fingerprint identification device, a face identification device and a barcode identification device.

According to an aspect of the present disclosure, there is provided a smart lumbar pillow system for chair, comprising:

at least one sensing element on a chair body for sensing a human body pressure on the chair body;

at least one gasbag on the chair body for supporting a waist of a human body;

a gas pump for performing inflation and deflation of the at least one gasbag; and

a control assembly in signal connection with the at least one sensing element and the gas pump.

### BRIEF DESCRIPTION OF THE DRAWINGS

FIG. 1 is a schematic view showing a structure of a chair according to an embodiment of the present disclosure;

FIG. 2 is a schematic view showing a smart lumbar pillow system for a chair according to an embodiment of the present disclosure; and

FIG. 3 is a control diagram of the smart lumbar pillow system for a chair according to the embodiment of the present disclosure.

### DETAILED DESCRIPTION

Technical solutions in embodiments of the present disclosure will be described clearly and completely hereinafter with reference to the attached drawings in the embodiments of the present disclosure. Obviously, the described embodiments are only some of embodiments of the present disclosure, instead of all the embodiments of the present disclosure. For those skilled in the art, all other embodiments achieved by referring to the following embodiments of the present disclosure without involving any inventive steps fall into the scope of the present disclosure.

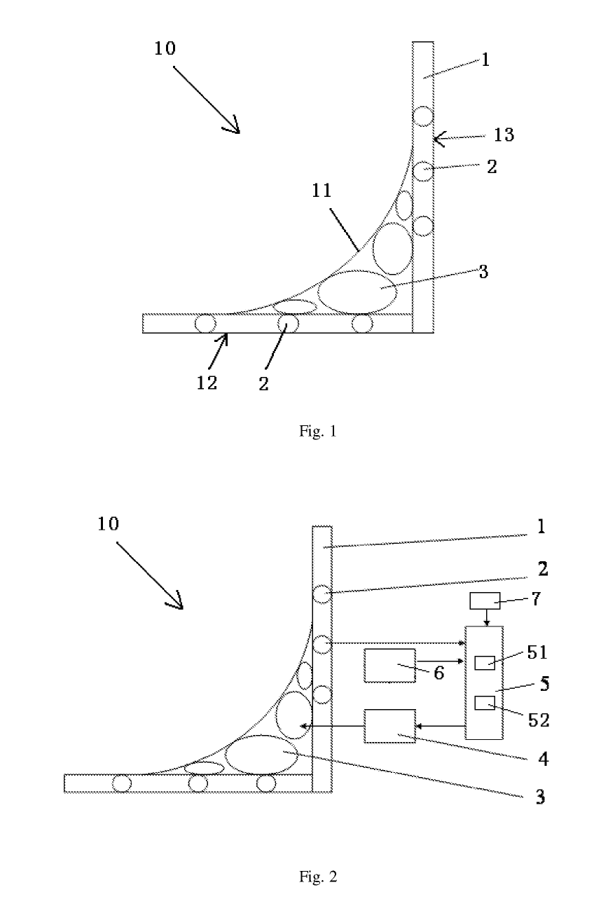

Referring to FIG. 1 and FIG. 2, according to an embodiment of the present disclosure, there is provided a chair. The chair comprises: a chair body 10; at least one sensing element 2 provided on the chair body 10 and configured for sensing a human body pressure on the chair body 10; at least one gasbag 3 provided on the chair body 10 and configured for supporting a waist of a human body; a gas pump 4 configured for performing inflation and/or deflation of the at least one gasbag 3; and a control assembly 5 being in signal connection with the at least one sensing element 2 and configured for controlling the gas pump 4 to perform inflation and/or deflation of the at least one gasbag 3 according to information acquired by the sensing element 2.

According to embodiments of the present disclosure, the sensing element can be, for example, a pressure sensor or any other suitable pressure sensing devices; and the control assembly can be, for example, a microcontroller or any other suitable controllers.

In the chair, the chair body is provided with the gasbag for supporting the human body's waist. When a user sits on the chair body, the user puts pressure on the chair body. The sensing element 2 acquires the user's pressure on the chair body and later transmits pressure data in the form of an electrical signal to the control assembly 5. The control assembly 5 controls the gas pump 4 to perform inflation and/or deflation of the gasbag 3 according to the electrical signal received, so as to adjust the gasbag 3 to be of a suitable size so that the gasbag 3 plays a good supporting role on the user's waist, which prevents the user from suffering lumbar spine fatigue and even lumbar spine disease caused by sitting or a long time, improves the comfort of the user sitting on the chair, and thus improves the user's work efficiency and learning efficiency.

It should be noted that, in the chair according to embodiment of the presents disclosure, a database in which relationships between pressure data sensed by the sensing element 2 and amounts of inflation of the airbag 3 are stored is provided in a memory (which will be described later in detail) of the control assembly 5. The sensing element 2 is disposed on the chair body to sense a pressure exerted on the chair body when the user sits on the chair body. When the sensing element 2 senses the user's pressure on the chair body, sensed pressure data is transmitted to the control assembly 5, and the control assembly 5 retrieves a corresponding amount of inflation of the airbag 3 from the database stored in advance in the memory according to the received pressure data. Then the air pump 4 is controlled by the control assembly 5 to inflate or deflate the airbag 3 in accordance with the amount of inflation of the airbag 3.

In addition, the sensing element transmits measured pressure data to the control assembly. According to the pressure data received, the control assembly retrieves a corresponding amount of inflation of the airbag 3 from the database, and automatically controls the gas pump to perform inflation and/or deflation of the gasbag, thereby realizing automatic control of a volume of the gasbag by the control assembly. When a user sits on the chair, the gasbag can automatically adjust its volume to support the user's waist, facilitating the use of the chair by the user.

Therefore, in the chair, the volume of the gasbag is automatically controlled by the control assembly 5, so that the gasbag plays a good supporting role for the user's waist, facilitating the use of the chair by the user. At the same time, the user is prevented from suffering lumbar spine fatigue and even lumbar spine disease caused by sitting for a long time, which improves the comfort of the user sitting on the chair, and thus improves the user's work efficiency and learning efficiency.

Specifically, signal connections between the control assembly 5 and the sensing element 2 and between the control assembly 5 and the gas pump 4 may adopt a wired connection. For example, they may be directly connected through a data line and the like to complete a data signal transmission. Of course, the signal connections between the control assembly 5 and the sensing element 2 and between the control assembly 5 and the gas pump 4 may also adopt a wireless connection. For example, the signal connections may be implemented through an infrared signal, a Bluetooth signal, and/or an electromagnetic induction signal, and the like, to complete the data signal transmission.

After the control assembly 5 receives the pressure data from the sensing element 2, the control assembly 5 retrieves a corresponding amount of inflation of the airbag 3 from the database stored in the memory according to the received pressure data, and then, in accordance with the corresponding amount of inflation of the airbag 3, the gas pump 4 is controlled by the control assembly 5 to perform inflation and/or deflation of the gasbag 3.

As an implementation of the chair body 10, the chair body comprises a chair frame 1 and a lumbar pillow 11, and the gasbag 3 is provided between the chair frame 1 and the lumbar pillow 11.

In the chair body 10, the gasbag 3 is provided between the chair frame 1 and the lumbar pillow 11. When a user sits on the chair body, the control assembly 5 retrieves a corresponding amount of inflation of the airbag 3 according to the pressure data transmitted from the sensing element 2, according to the pressure data transmitted to the control assembly 5 from the sensing element 2, and controls the gas pump 4 to perform inflation and/or deflation of the gasbag 3. When the gasbag 3 is required to be inflated, the gasbag 3 expands, pushes the lumbar pillow 11 towards the user, and finally pushes the lumbar pillow 11 to the user's waist, for supporting the waist. When the gasbag 3 is required to be deflated, the control assembly 5 retrieves a corresponding amount of inflation of the airbag 3 from the database stored in the memory according to the pressure data transmitted from the sensing element 2, the volume of the gasbag 3 is appropriately reduced until the lumbar pillow 11 is adjusted to a position which conforms to the shape of the user's waist curve and supports the user's waist for avoiding the user from suffering waist fatigue.

Specifically, a plurality of sensing elements 2 are provided on different parts of the chair frame 1.

In the chair body, a plurality of sensing elements 2 is provided on different parts of the chair frame 1. When the user sits on the chair body, the user puts different pressures on parts of the chair frame 1, that is, the pressure data measured by the sensing elements 2 are different. Each sensing element 2 transmits the acquired pressure data in the form of a pressure signal to the control assembly 5. The control assembly 5 adjusts the amount of inflation or the amount of deflation of the gasbag 3 corresponding to the pressure data acquired by each sensing element 2, and thereby adjusts the gasbag 3 and the lumbar pillow 11 to conform to the shape of the human body's waist.

Specifically, the chair frame 1 comprises a backboard 13 and a seat board 12, and both the backboard 13 and the seat board 12 are provided with the sensing elements 2.

In the chair frame 1, both the backboard 13 and the seat board 12 are provided with sensing elements 2. When a user sits on the seat body, different pressure data sensed by these sensing elements 2 constitute a data group corresponding to the user's setting posture. The control component 5 receives the data group, judges a main force receiving part of the seat body based on one pressure data (e.g., a maximum pressure data) of the data group, retrieves a corresponding amount of inflation of the airbag 3 corresponding to the one pressure data, and then controls the air pump 4 to inflate or deflate the airbag 3. In this way, according to the different pressure data collected by the sensing elements 2, the control assembly 5 analyzes the user's sitting posture. In such a way, when the user sits on the chair in any sitting posture, the control assembly 5 can control the inflation and/or deflation of the gasbag 3, so that the shape of the gasbag 3 conforms to the user's waist, completing the support for the user's waist. In one embodiment, two to four sensing elements 2 are provided on each of the backboard 13 and the seat board 12, and these sensing elements 2 are substantially symmetrically arranged along a central line of the chair body 2.

In one implementation, the chair comprises a plurality of gasbags 3 provided respectively on the backboard 13 and the seat board 12. In one embodiment, the plurality of gasbags 3 are provided at a connection between the backboard 13 and the seat board 12. One or more sensing element 2 can be provided for each gasbag 3.

The user's pressure on the chair body is transmitted to the sensing elements 2. According to different pressure data measured by the sensing elements 2, the control assembly 5 controls each of the gasbags 3, to inflate or deflate the gasbag 3, so that, compared with a case where only single gasbag is provided, the overall shape of the gasbags 3 conforms to the user's waist and provides good support for the user's waist.

In one implementation, the chair further comprises a manual control switch 6 connected to the gas pump 4 and configured for manually performing inflations and deflations of the gasbags.

In the chair, when the user sits on the chair body, according to the user's own needs, inflation or deflation of each of the gasbags 3 can be controlled through the manual control switch, to adjust the volume of each of the gasbags 3 and make the gasbags to meet the user's needs.

In an implementation, the control assembly 5 further comprises: a data processor 51 configured for processing the information from the sensing element 2 and outputting an electrical signal, and a memory 52 in signal connection with the data processor 51 and configured for storing a user data. In some embodiments, the data processor 51 can be a microcontroller, and the memory 52 can be a nonvolatile memory.

The data processor 51 of the control assembly 5 processes the signal received from the sensing element 2, and converts it into an electrical signal that is later transmitted to the gas pump 4. At the same time, the control assembly 5 transmits the signal received from the sensing element 2 to the memory 52, for storing the user data. When the user uses chair again, the data in the memory 52 can be called up, thereby facilitating the user to use the chair.

Specifically, after the gasbag is fine-tuned by the user, the memory 52 may also store the updated data, as an initial data of the gasbag when the chair is used next time.

In an implementation, the chair body is provided with an identification device 7 configured for identifying different users in accordance with the user's setting posture. The control assembly 5 is further configured for: retrieving the user data stored in the memory 52 according to the identification of the user by the identification device 7, and controlling the gas pump 4 to perform inflation and deflation of the gasbag 3 according to the user data. Here, the user data includes an amount of inflation of the gasbag 3 or an amount of deflation of the gasbag 3 required for the user's setting posture. When a user sits on the chair body, the data stored by the user in the memory 52 is called up by the identification device 7, and then the gasbags are inflated or deflated according to the retrieved data.

In the chair body, it is possible to store usage data of a plurality of users. Since the chair is used in different occasions, the chair may have a plurality of long-term users. In this case, the memory may store the usage data of different users separately. When a user who has stored the usage data needs to use the chair, only the usage data of this user is called up, and then the control assembly 5 completes the adjustment of the gasbags according to the retrieved usage data.

Specifically, the identification device comprises at least one of a fingerprint identification device, a face identification device and a barcode identification device.

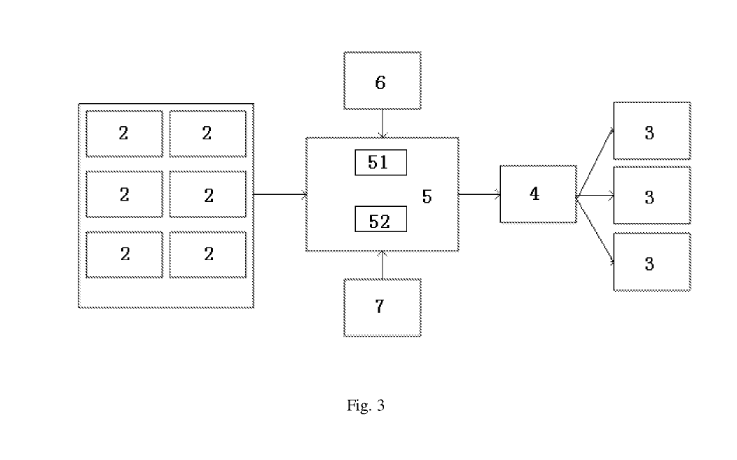

According to an embodiment of the present disclosure, there is further provided a smart lumbar pillow system for chair. Referring to FIG. 3, the smart lumbar pillow system comprises: a sensing element 2 provided on a chair body and configured for sensing a human body pressure on the chair body; a gasbag 3 provided on the chair body and configured for supporting a waist of a human body; a gas pump 4 configured for performing inflation and deflation of the gasbag 3; and a control assembly 5 being in signal connection with the sensing element 2 and the gas pump 4.

The above-mentioned smart lumbar pillow system for chair can be used in the chair according to any one of the above-mentioned embodiments.

The smart lumbar pillow system for chair can be applied to an office chair, a home chair, a chair or sofa in a transportation device such as a vehicle. The automatic control of the gasbag(s) through the control assembly can achieve good support for the user's waist, thereby avoiding the user from suffering lumbar spine fatigue and even lumbar spine disease caused by long time sitting, improving the comfort of the user sitting on the chair.

It would be apparent to those skilled in the art that various modifications and alternations can be made to the embodiments of the present disclosure without departing from the spirit and scope of the present disclosure. Thus, if these modifications and alternations of the embodiments fall within the scope of the present disclosure, which is defined by the appended claims and its equivalents, the present disclosure also intends to comprise these modifications and alternations.

What is claimed is:

1. A chair comprising:
a chair body;
at least one sensing element on the chair body configured for sensing a human body pressure on the chair body;
at least one gasbag on the chair body configured for supporting a waist of a human body;
a gas pump operable for performing inflation and deflation of the at least one gasbag; and
a control assembly in signal connection with the at least one sensing element for controlling the gas pump to perform inflation and deflation of the at least one gasbag according to information acquired by the sensing element.

2. The chair of claim 1, wherein the chair body comprises a chair frame and a lumbar pillow, and the at least one gasbag is between the chair frame and the lumbar pillow.

3. The chair of claim 2, wherein the at least one sensing element comprises a plurality of sensing elements on the chair frame.

4. The chair of claim 3, wherein the chair frame comprises a backboard and a seat board, and both the backboard and the seat board are provided with the sensing elements.

5. The chair of claim 4, wherein the backboard and the seat board are respectively provided with two to four of the sensing elements, and the sensing elements are substantially symmetrically arranged along a central line of the chair body.

6. The chair of claim 4, wherein the at least one gasbag comprises a plurality of gasbags respectively on the backboard and the seat board.

7. The chair of claim 1, further comprising a manual control switch connected to the gas pump and configured for manually performing inflation and deflation of the at least one gasbag.

8. The chair of claim 1, wherein the control assembly comprises: a data processor for processing the information from the at least one sensing element and outputting an electrical signal, and a memory in signal connection with the data processor for storing user data.

9. The chair of claim 8, wherein the chair body is provided with an identification device for identifying different users.

10. The chair of claim 9, wherein the control assembly is configured for: retrieving the user data stored in the memory according to an identification of user identified by the identification device, and controlling the gas pump to perform inflation and deflation of the at least one gasbag according to the user data.

11. The chair of claim 9, wherein the identification device comprises at least one of a fingerprint identification device, a face identification device and a barcode identification device.

12. A smart lumbar pillow system for chair, comprising:
at least one sensing element on a chair body configured for sensing human body pressure on the chair body;
at least one gasbag on the chair body configured for supporting a waist of a human body;
a gas pump operable for performing inflation and deflation of the at least one gasbag; and
a control assembly in signal connection with the at least one sensing element and the gas pump.
